(19) United States
(12) Patent Application Publication
(10) Pub. No.: US 2008/0013302 A1
(43) Pub. Date: Jan. 17, 2008

(54) Motion-responsive illuminated articles

(76) Inventor: Ezra Esses, Brooklyn, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/827,955

(22) Filed: Jul. 12, 2007

Related U.S. Application Data
(60) Provisional application No. 60/831,382, filed on Jul. 17, 2006.

(51) Int. Cl. F21V 33/00; F21L 4/00

(52) U.S. Cl. 362/99; 362/109; 362/190

(57) ABSTRACT

Articles such as stationery and office supplies are illuminated with flashing lights in response to movement by a user.

### CROSS-REFERENCE TO RELATED APPLICATION

This application claims the priority benefit of U.S. Provisional Patent Application Ser. No. 60/831,382, filed Jul. 17, 2006.

### BACKGROUND OF THE INVENTION

1. Field of the Invention

The present invention generally relates to articles such as stationery and home/office supplies that are illuminated in response to motion by users, especially children.

2. Description of the Related Art

Stationery and home/office supplies, such as staplers, erasers, scissors, rulers, tape dispensers, and notepads, are well known and, indeed, substantial effort has been expended for many years in improving the construction and operation of such stationery products. As advantageous as these known stationery products have been, improvements can still be made in their use, particularly for providing a more visually stimulating appearance and for enhancing their use by children, as well as the ability of having individuals easily identify the owner of these products. However, in spite of this substantial effort, difficulties continue to exist.

### SUMMARY OF THE INVENTION

### Object of the Invention

Accordingly, it is a general object of this invention to provide a visually stimulating, eye-catching display on articles, such as stationery and home/office supplies.

### Features of the Invention

In keeping with the above object and others that will become apparent hereinafter, one feature of the present invention resides, briefly stated, in motion-responsive illuminated articles, such as stationery and home/office supplies, including but not limited to a stapler, a notepad, an eraser, a photograph frame, a carrying bag, and so on, and indeed virtually any portable, mobile article that is moved either prior to, during, or after its use.

The article includes a lighting module for emitting light in response to motion by a user. The module includes a battery, at least one light source and preferably a plurality of light sources, a processor, and a motion-responsive switch for connecting the battery to the processor and to the light sources to cause the latter to flash light in accordance with a pattern determined by the processor.

The module is overlaid by a top wall of soft or hard plastic material. The top wall may be imperforate, in which case, it is transmissive to the light flashed by the light sources. The top wall may be apertured, in which case, the light sources are situated in and exposed at the apertures. Preferably, a graphic is provided on the overlay.

In accordance with one feature of this invention, the flashing lights create an eye-catching display when the module supported by the article is moved. This promotes the use and the repeated use of the articles by children, since the children enjoy making the lights flash over and over again. Also, a child can easily identify himself or herself as the owner of a particular stationery product since it is the only one that flashes when moved.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1A is a front isometric view of a motion-responsive, illuminatable carrying bag in accordance with this invention;

FIG. 1B is a front isometric view of a motion-responsive, illuminatable holder for an eraser in accordance with this invention;

FIG. 1C is a front isometric view of a motion-responsive, illuminatable photograph frame in accordance with this invention;

FIG. 1D is a front isometric view of a motion-responsive, illuminatable stapler in accordance with this invention;

FIG. 1E is a front isometric view of a motion-responsive, illuminatable notepad in accordance with this invention;

FIG. 2 is an enlarged sectional view taken on line 2-2 of FIG. 1;

FIG. 3 is a perspective view of an encapsulated lighting module for use with this invention;

FIG. 4 is an exploded view of the lighting module prior to assembly and encapsulation; and

FIG. 5 is an electrical schematic of a circuit used in the lighting module of FIG. 3.

### DETAILED DESCRIPTION OF THE PREFERRED EMBODIMENT

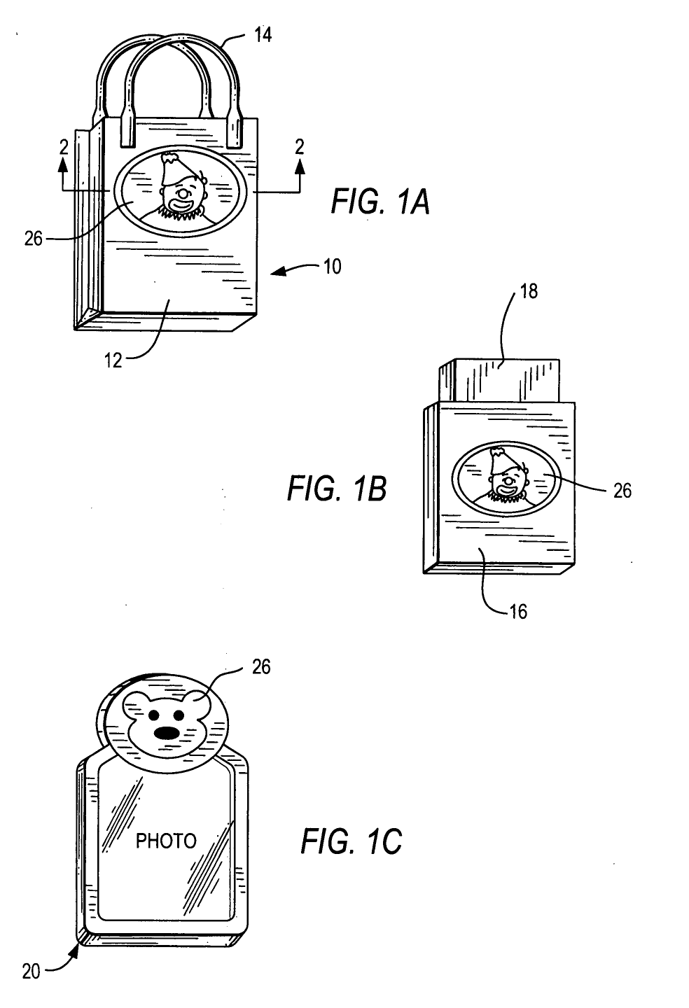

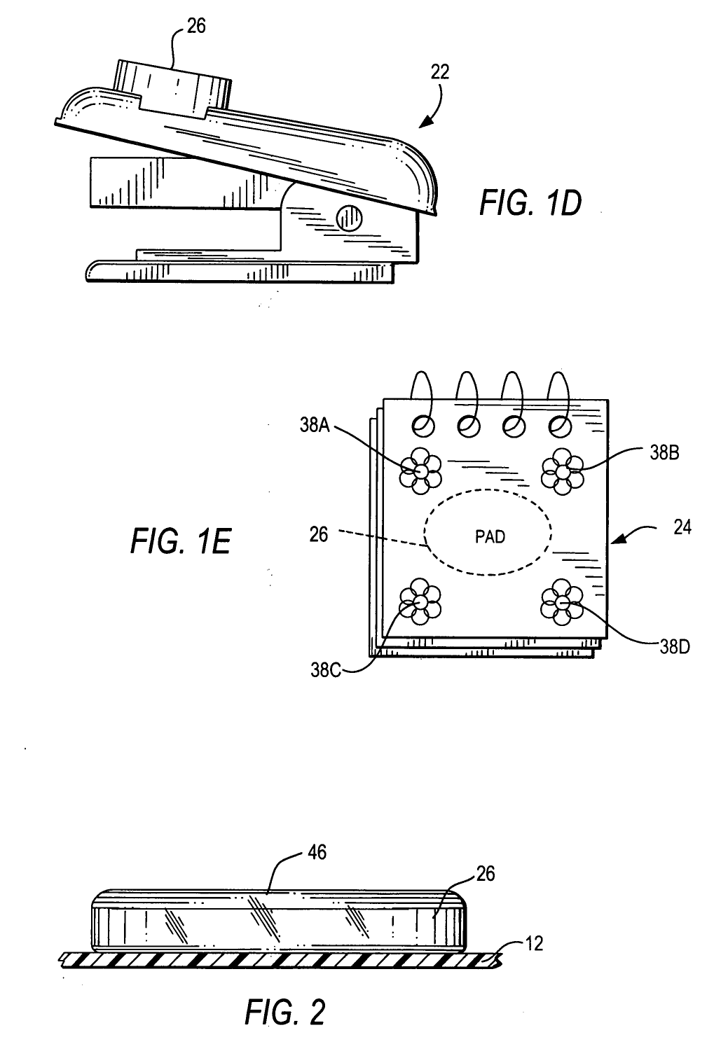

Referring now to the drawings, reference numeral 10 in FIG. 1A generally identifies a carrying bag having a pair of juxtaposed panels 12 bounding an interior, and a handle 14 for carrying the bag and its contents from place to place. Reference numeral 16 in FIG. 1B generally identifies a generally rectangular holder for a generally rectangular eraser 18. The eraser can be used to erase markings while held in the holder, or the eraser can be removed therefrom. Reference numeral 20 in FIG. 1C generally identifies a photograph frame that is movable from place to place on a horizontal support surface, such as a desk. Reference numeral 22 in FIG. 1E generally identifies a stapler having a movable arm to staple documents. Reference numeral 24 in FIG. 1F generally identifies a notepad having a cover movable to expose sheets of blank or preprinted paper therein.

A lighting module 26 is mounted on the panel 12 of the bag (see FIG. 2), on the eraser holder 16, on the frame 20, on an upper arm of the stapler 22, or within the cover of the notepad 24. As best seen in the exploded view of FIG. 4, the module 26 includes a battery 28, typically a flat circular disk battery commonly used in cameras, a battery holder 30 having a resilient finger 32 for engaging one side of the battery, a planar support such as a printed circuit board 34, a processor 36 mounted on the board 34, at least one light source and preferably a plurality of light sources 38A, B, C, D also mounted on the board 34, and a motion-responsive switch 40 electrically connected to the processor 36, the battery 28, and the light sources 38A, B, C, D in the manner illustrated in the circuit of FIG. 5.

The switch 40 includes an electrically conductive outer sleeve 42 in which an electrically conductive coil spring 44 is mounted for movement between an open position in which the spring is located out of physical conductive contact with the sleeve 42, and a closed position in which the spring contacts the sleeve 42. Motion of the spring is caused by movement of the respective article and, to aid such spring motion, the free end of the cantilevered spring 44 can be weighted.

In the closed position of the switch 40, the processor is energized by the battery and causes the light sources to emit light, preferably flashes of light in a pattern determined by the processor. The pattern may be predetermined or random. The flashing can occur immediately when the closed position is reached, or after a time delay. The flashing is terminated after a predetermined time, or after a randomly chosen time interval. Continuous illumination is contemplated, but not preferred to minimize power consumption.

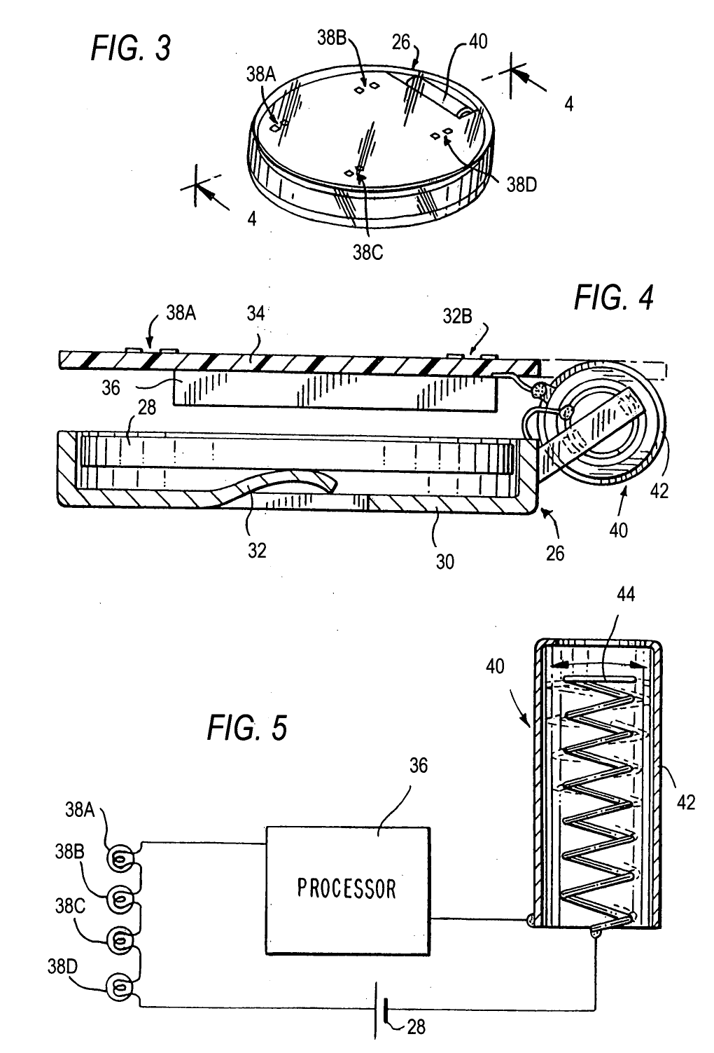

The light sources are light emitting diodes operative for emitting light of the same or different colors. Each diode includes a pair of planar electrodes, as best seen in FIG. 3, which are flush-mounted on an exterior planar surface of the board 34.

The module is overlaid by a top wall 46 of soft (FIG. 1A, C) or hard plastic material (FIG. 1B, D). The top wall may be imperforate, in which case, it is transmissive to the light flashed by the light sources (see FIG. 1A, B, D). The top wall may be apertured, in which case, the light sources are situated in the apertures (see FIG. 1E). Preferably, a graphic, such as the illustrated three-dimensional clown or cat face, is printed on, attached to, or molded in, the top wall. As best seen in FIG. 3, the module 26 may be encapsulated in a synthetic plastic material that is preferably light-transmissive. The encapsulated module has smooth, flattened major surfaces and has a circular or ovoidal disk shape. All of the components of the module are preferably potted inside the encapsulated plastic, and there are no exposed rough edges. The encapsulating plastic was not shown in FIG. 4 so as not to encumber this drawing. The module may be adhered, molded, heat-fused about a peripheral seal, or otherwise connected, to the article for joint movement therewith.

In use, the module is mounted on or in the article. As the user moves the article, the light emitted by the module passes through the light-transmissive encapsulating plastic and the light-transmissive top wall, or the apertures in the top wall, and illuminates the graphic thereon. The flashing lights enhances use and repeated use of the articles by children, since the children enjoy making the lights flash over and over again. Also, a child can easily identify himself or herself as the owner of a particular stationery product since it is the only one that flashes when moved.

It will be understood that each of the elements described above, or two or more together, also may find a useful application in other types of constructions differing from the types described above.

While the invention has been illustrated and described as embodied in a motion-responsive, illuminated article, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A motion-responsive, illuminated article, comprising:
a portable, mobile support; and
a lighting module mounted on the support for joint movement therewith, for emitting light in response to motion by a user, the module including a battery for supplying electrical power, a light source, and a motion-responsive switch for connecting the battery to the light source to power the latter to emit light.

2. The article of claim 1, wherein the lighting module includes a processor for flashing the light source when the battery is connected to the light source by the motion-responsive switch.

3. The article of claim 2, wherein additional light sources are operatively connected to the processor for flashing all the light sources in a pattern.

4. The article of claim 1, wherein the motion-responsive switch includes a coil spring mounted within a sleeve for movement between an open position in which the spring is spaced from the sleeve, to a closed position in which the spring contacts the sleeve.

5. The article of claim 1, wherein the lighting module includes a planar support, and wherein the light source is a light emitting diode having planar electrodes mounted flush with the planar support.

6. The article of claim 1, and an overlay attached to the support and bounding therewith a compartment in which the module is received and held, the overlay being transmissive to the light emitted by the module.

7. The stocking of claim 6, wherein the overlay has a graphic illuminated by the light flashed by the light source.

8. The article of claim 1, and a heat-fused seal extending around a periphery of the overlay and sealing the overlay to the support.

9. The article of claim 1, wherein the module includes a flattened disk in which the module is encapsulated in a synthetic plastic, light-transmissive, material.

10. The article of claim 1, wherein the support is a bag having carrying handles.

11. The article of claim 1, wherein the support is a holder for an eraser.

12. The article of claim 1, wherein the support is a photograph frame.

13. The article of claim 1, wherein the support is a stapler.

14. The article of claim 1, wherein the support is a notepad having sheets of paper.

15. A motion-responsive, illuminated article, comprising:
a portable, mobile item of stationery; and
a lighting module for emitting light in response to motion by a user of the stationery item, the module including a battery for supplying electrical power, a plurality of light sources, a processor, and a motion-responsive switch for connecting the battery to the processor and the light sources to cause the light sources to flash light in accordance with a pattern determined by the processor, the module being transmissive to the light flashed by the light sources.

16. The article of claim 1, wherein the stationery item is a bag having carrying handles.

17. The article of claim 1, wherein the stationery item is a holder for an eraser.

18. The article of claim 1, wherein the stationery item is a photograph frame.

19. The article of claim 1, wherein the stationery item is a stapler.

20. The article of claim 1, wherein the stationery item is a notepad having sheets of paper.
